(19) United States
(12) Patent Application Publication
(10) Pub. No.: US 2022/0064519 A1
(43) Pub. Date: Mar. 3, 2022

(54) VISCOELASTIC COMPOSITIONS FOR MATRIX ACIDIZING

(71) Applicant: OXITENO S.A. INDÚSTRIA E COMÉRCIO, São Paulo (BR)

(72) Inventors: Jaqueline Martins DE PAULO, Santo André (BR); Rodrigo Balloni RABELO, São Paulo (BR); Marilia Aparecida DE ANDRADE, São Caetano do Sul (BR); Olivia Cueva Candido POLTRONIERI, São Paulo (BR); Conrado Gerard EWBANK, São Paulo (BR); Camila Oliveira GUIMARÃES, São Paulo (BR); Erica Regina BURATINI, SÃO PAULO (BR); Hisham NASR-EL-DIN, College Station, TX (US); Ahmed Farid IBRAHIM, College Station, TX (US)

(21) Appl. No.: 17/417,668

(22) PCT Filed: Oct. 25, 2019
(86) PCT No.: PCT/IB2019/001152

§ 371 Date: Jun. 23, 2021

(30) Foreign Application Priority Data
Jan. 31, 2019 (BR) BR 10 2019 002052

(51) Int. Cl. C09K 8/74; C09K 8/584; E21B 43/28

(52) U.S. Cl. CPC C09K 8/74; C09K 8/584; C09K 2208/32; C09K 2208/30; E21B 43/283

(57) ABSTRACT

Viscoelastic compositions suitable for use as diversion agents in a process for acidizing a carbonate-based subterranean oilfield formation are disclosed. The compositions comprise water, a tall oil fatty acid (TOFA)-based amidoamine betaine, a C₁-C₄ alcohol, and propylene glycol. The invention includes an acidizing process that utilizes a mineral acid and an effective amount of the viscoelastic composition. The viscoelastic compositions effectively divert acid flow, thereby optimizing acid utilization and minimizing acid spend. The compositions fully develop formations, stabilize and/or promote formation of worm-like micelles, and maintain a high, stable viscosity during an acidizing process. Surprisingly, the compositions perform well at low surfactant does, high pressures, and temperatures greater than 350° F. The compositions can tolerate higher levels of corrosion inhibitors than known alternatives and can be used in formations having ferric ion contents greater than 10,000 ppm.

### FIELD OF THE INVENTION

The invention relates to viscoelastic compositions useful as diversion agents for acidizing carbonate-rich subterranean formations.

### BACKGROUND OF THE INVENTION

Matrix acidizing is an effective well stimulation process that reduces damage in carbonate-rich formations. The acidizing mixture is injected at a pressure below the fracturing pressure to dissolve pore-clogging materials in sandstone or to create new wormholes in carbonate formations. Hydrochloric acid (HCl) is commonly used because of its availability and low cost. In heterogeneous formations, polymers and/or surfactants are included to divert acid flow to maximize the benefits of acidizing.

Viscoelastic surfactants have been used for matrix acidizing, and they are easier to clean and mix compared with in-situ polymer-based acid systems. Viscoelastic surfactants form gels in aqueous media at low temperatures, and the mixtures retain a very high viscosity and viscoelasticity at temperatures greater than 80° C.

During carbonates acidizing with viscoelastic surfactants, concentrations of calcium chloride and magnesium chloride increase. This promotes conversion of spherical micelles to worm-like structures that entangle to form a three-dimensional network (see, e.g., T. McCoy et al., J. Colloid Interface Sci. 534 (2019) 518). Consequently, the apparent viscosity of the solution increases, which is helpful for developing the formation.

Viscoelastic surfactant systems generally exhibit diminished performance when corrosion inhibitors are included. Generally, no more than about 2 vol. % of a corrosion inhibitor can be tolerated without sacrificing viscosity stability. Other additives or contaminants commonly present in formations, e.g., ferric ion, can also limit performance of viscoelastic surfactant systems.

Several classes of viscoelastic surfactants are currently used as acid diverting agents: cationic, amine oxide-based, and betaine- or sultaine- (i.e., sulfobetaine) based. U.S. Pat. Nos. 8,887,804; 9,034,806; 9,341,052; 9,080,095; 7,119,050; and 7,341,980 are representative. Betaine-based surfactants are stable in brines and have a permanent positive charge independent of pH. Reported compositions include amidoamine betaines from pure oleic acid or from soy-based fatty acids. These surfactants can degrade during use at temperatures greater than 80° C. or 100° C. in saline oil reservoirs thereby nullifying any viscosifying advantage of the drive fluid.

Betaines from various fatty acids, including tall oil fatty acids (TOFA), have been used for oil recovery, especially enhanced oil recovery (see, e.g., U.S. Pat. Nos. 7,373,977 and 7,556,098), but TOFA-based betaine compositions apparently have not been suggested for use in matrix acidizing.

The industry would benefit from new viscoelastic compositions suitable for use in matrix acidizing. Preferred compositions would divert acid flow to optimize acid utilization and formation development, stabilize and/or promote formation of worm-like micelles, and maintain a high, stable viscosity during an acidizing process. Ideally, the compositions could be used under stressed conditions of surfactant dosing as low as 4 vol. %, pressures as high as 400 psi and temperatures greater than 350° F. Compositions that can tolerate high levels of corrosion inhibitors and formation-specific complications, such as high ferric ion content, are needed.

### SUMMARY OF THE INVENTION

In one aspect, the invention relates to a viscoelastic composition that is suitable for use as a diversion agent in a process for acidizing a carbonate-based subterranean oilfield formation. The composition comprises: (a) 20 to 35 wt. % of a tall oil fatty acid (TOFA)-based amidoamine betaine; (b) 5 to 10 wt. % of a C₁-C₄ alcohol; (c) 10 to 20 wt. % of propylene glycol; and (d) 30 to 60 wt. % of water. These wt. % amounts are based on the amount of viscoelastic composition.

In a particular aspect, the TOFA-based amidoamine betaine has the structure:

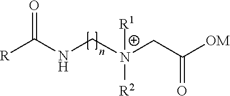

wherein n has a value from 1 to 4, R is a saturated or unsaturated fatty chain from tall oil, R¹ and R² are independently methyl or ethyl, M is an alkali metal cation or an ammonium cation, and wherein the betaine is based on a TOFA comprising 5 to 10 wt. % of palmitic acid, 35 to 55 wt. % of oleic acid, and 30 to 45 wt. % of linoleic acid, said wt. % amounts based on the amount of TOFA.

In other aspects, the invention relates to an acidizing process. The process comprises acidizing a carbonate-rich subterranean oilfield formation with an acidizing medium comprising a mineral acid and an effective amount of the viscoelastic compositions described above.

The inventive viscoelastic compositions are valuable for matrix acidizing of carbonate-rich subterranean formations. We found that the compositions effectively divert acid flow, thereby optimizing acid utilization and minimizing acid spend. The compositions promote formation of worm-like channels and maintain a high, stable viscosity during an acidizing process. Surprisingly, the compositions perform well under stressed conditions of surfactant dosage as low as 4 vol. %, pressures as high as 400 psi and temperatures greater than 350° F. The compositions can tolerate higher levels of corrosion inhibitors than known alternatives and can be used in formations having ferric ion contents greater than 10,000 ppm.

### BRIEF DESCRIPTION OF THE DRAWINGS

FIG. 1 plots results from a single experiment using a Graves HPHT M5600 viscometer wherein the viscoelastic composition includes a TOFA amidoamine betaine and 6.0 vol. % of the viscoelastic composition is used along with 2.0 vol. % corrosion inhibitor and 20 wt. % CaCl₂ at 400 psi and 250° F. at a shear rate of 100 s⁻¹. See Example 4.

FIG. 2 is a schematic of the apparatus used for coreflood experiments.

FIG. 3 plots the pressure-drop results of a coreflood experiment using a commercial sultaine-based viscoelastic composition.

FIG. 4 plots the pressure-drop results of a coreflood experiment using a TOFA amidoamine betaine viscoelastic composition.

FIG. 5A is a computed tomography (CT) scan showing the path of acid diversion using a commercial sultaine-based viscoelastic composition.

FIG. 5B is a CT scan showing the path of acid diversion using a TOFA amidoamine betaine viscoelastic composition.

### DETAILED DESCRIPTION OF THE INVENTION

In one aspect, the invention relates to a viscoelastic composition suitable for use as a diversion agent in a process for acidizing a carbonate-based subterranean oilfield formation. The composition comprises a TOFA-based amidoamine betaine, a C₁-C₄ alcohol, propylene glycol, and water.

A. Viscoelastic Composition

1. TOFA-Based Amidoamine Betaine

The viscoelastic compositions include 20 to 35 wt. % or 20 to 30 wt. % (based on the amount of viscoelastic composition) of a TOFA-based amidoamine betaine.

“TOFA” refers to tall oil fatty acid, a product made by vacuum distillation of crude tall oil (CTO). Depending on the source of the CTO and the means and conditions of purification, the TOFA product will contain varying proportions of fatty acids (the principal constituent), resin acids (mainly abietic acid and its isomers), fatty alcohols, sterols, and other components.

The principal fatty acid components of TOFA include oleic acid (C18, monounsaturated), linoleic acid (C18, diunsaturated), and palmitic acid (Cm, saturated). Other fatty acid components, such as branched C16 saturated acids and stearic acid (C18, saturated) are usually present in minor proportion.

In some aspects, the TOFA used to produce the TOFA-based amidoamine betaine comprises 5 to 10 wt. % of palmitic acid, 40 to 55 wt. % of oleic acid, and 35 to 45 wt. % of linoleic acid, said wt. % amounts based on the amount of TOFA.

Compared with the fatty acid content of most other natural oils (e.g., soybean oil, sunflower oil, canola oil), and because of its high content of oleic acid and linoleic acid, TOFA has an unusually high unsaturation content. Typically, 90 to 98 wt. % of the TOFA is unsaturated.

Well-known chemistry is used to convert TOFA to a TOFA-based amidoamine (see, e.g., U.S. Pat. Nos. 7,373,977 and 7,556,098, the teachings of which are incorporated herein by reference). Reaction of TOFA with an amidoamine (such as DMAPA (N,N-dimethyl-3-aminopropylamine), N,N-dimethyl-2-aminoethylamine, or N,N-dimethyl-4-aminobutyl-amine) is performed by heating the reactants at elevated temperature with removal of water to a targeted acid number, followed by vacuum stripping to remove unreacted DMAPA. The reaction can be performed in the presence of hypophosphorous acid to minimize color development.

Conversion of the TOFA-based amidoamine to the corresponding betaine is also accomplished using well-known chemistry (see, e.g., U.S. Pat. Nos. 7,373,977 and 7,556,098, the teachings of which are incorporated herein by reference. The TOFA-based amidoamine is combined with water, propylene glycol, and sodium monochloroacetate and heated in the presence of enough of an alkali metal hydroxide, preferably sodium hydroxide, to maintain pH>9. The resulting betaine product can be used without further purification to produce an inventive viscoelastic composition.

In some aspects, the TOFA-based amidoamine betaine has the structure:

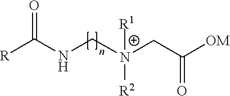

wherein n has a value from 1 to 4, R is a saturated or unsaturated fatty chain from tall oil, R¹ and R² are independently methyl or ethyl, M is an alkali metal cation or an ammonium cation. Consistent with the nature of tall oil, R will normally have a distribution of saturated and unsaturated carbon chains of various lengths. Most of the chains will have from 8 to 30 carbons, or from 12 to 24 carbons, or from 16 to 18 carbons. The acid residues present are in many aspects principally from stearic acid, palmitic acid, oleic acid, linoleic acid, and linolenic acid. Preferably, the betaine is based on a TOFA comprising 5 to 10 wt. % of palmitic acid, 35 to 55 wt. % of oleic acid, and 30 to 45 wt. % of linoleic acid, said wt. % amounts based on the amount of TOFA. In some aspects, the TOFA also comprises 1 to 3 wt. % of stearic acid. In other aspects, the betaine is based on a TOFA comprising 6 to 8 wt. % of palmitic acid, 1.5 to 3 wt. % of stearic acid, 40 to 52 wt. % of oleic acid, and 35 to 42 wt. % of linoleic acid.

2. C₁-C₄ Alcohol

The viscoelastic compositions include 5 to 10 wt. % or 6 to 9 wt. % or 6.5 to 8.5 wt. % (based on the amount of viscoelastic composition) of a C₁-C₄ alcohol. Suitable C₁-C₄ alcohols include methanol, ethanol, n-propyl alcohol, isopropyl alcohol, n-butyl alcohol, sec-butyl alcohol, and tert-butyl alcohol. Ethanol is preferred.

3. Propylene Glycol

The viscoelastic compositions include 10 to 20 wt. % or 12 to 18 wt. % or 13 to 16 wt. % (based on the amount of viscoelastic composition) of propylene glycol.

The weight ratio of propylene glycol to the C₁-C₄ alcohol, preferably ethanol, is within the range of 3.0:1 to 1.5:1, or within the range of 2.5:1 to 1.8:1.

4. Water

The viscoelastic compositions include 30 to 60 wt. % or 35 to 55 wt. % or 40 to 52 wt. % (based on the amount of viscoelastic composition) of water.

B. Acidizing Process

In some aspects, the invention relates to a matrix acidizing process. The process comprises acidizing a carbonate-rich subterranean oilfield formation with an acidizing medium comprising a mineral acid and an effective amount of an inventive viscoelastic composition as described above.

Acidizing is a well-stimulation process. Introduction of the acid triggers a reaction with carbonate-rich rock to create channels within the formation pores through which additional oil can pass and be recovered. Prior to oil recovery, the channels are created with acid and tortuosity is increased with help from the viscoelastic composition.

Suitable mineral acids include hydrochloric acid, sulfuric acid, phosphoric acid, nitric acid, and the like. Hydrochloric acid is preferred. Typically, the acid will be diluted to 1 to 20 wt. % or 5 to 15 wt. % prior to use.

In the acidizing process, the viscoelastic composition is dosed to the formation at a desired level, typically within the range of 4 to 10 vol. %, or 6 to 8 vol. %, based on the combined amounts of acidizing medium and viscoelastic composition.

The acidizing is performed at any convenient temperature, typically at a temperature within the range of 200° F. to 400° F. or from 250° F. to 350° F. The acidizing is performed at any convenient pressure, typically at a pressure within the range of 200 psi to 500 psi, or from 300 psi to 400 psi.

The viscoelastic compositions of the invention are suitable for use in formations characterized by high contents of iron(III), from relatively low contents of 1,000 ppm to high contents of 10,000 ppm or more of iron(III) content. Viscoelastic compositions currently available tolerate only about 3,000 ppm of iron(III) content.

In some aspects, the acidizing process is performed in the presence of a corrosion inhibitor. Suitable corrosion inhibitors are commercially available. Because commercial corrosion inhibitors come in many varieties and usually have multiple active components, it may be necessary to test the corrosion inhibitor with the inventive viscoelastic composition to confirm its suitability for use under the conditions applicable. This is left to the skilled person's discretion.

The following examples illustrate the invention. The skilled person will immediately recognize many variations that are within the spirit of the invention and scope of the claims.

Tall Oil Fatty Acid (TOFA) Analysis

The TOFA used to produce the amidopropylamine betaines is obtained commercially and is used as supplied. Analysis of a sample reveals the following proportion of fatty acids:

Palmitic acid (C₁₆, saturated): 7.9 wt. %

Branched, saturated C₁₆ acids: 1.0 wt. %

Stearic acid (C₁₈, saturated): 2.1 wt. %

Oleic acid (C₁₈, monounsaturated): 50.2 wt. %

Linoleic acid (C₁₈, diunsaturated): 38.8 wt. %

### Preparation of a TOFA-Based Amidopropylamine

Tall oil fatty acid (69.4 g, 0.235 mol), N,N-dimethylaminopropylamine (“DMAPA,” 30.6 g, 0.300 mol), and hypophosphorous acid (about 2 mg) are charged to a round-bottom flask equipped with heating mantle, mechanical stirrer, thermometer, distillation head, and nitrogen inlet. The mixture is heated slowly with stirring to 175° C.-185° C. with removal of water until the acid number is less than 8 mg KOH/g. Unreacted DMAPA is then removed by heating to 180° C. under vacuum (<100 mm Hg) for 6-10 h. The fatty amidoamine product contains about 4 wt. % of free TOFA fatty acids.

### Preparation of an Amidoamine Betaine

TOFA-based amidopropylamine (23.0 g, 0.063 mol), water (45.0 g, 2.50 mol), propylene glycol (14.0 g, 0.184 mol), ethanol (9.00 g, 0.195 mol) and sodium monochloroacetate (8.6 g, 0.074 mol) are charged to a round-bottom flask equipped with heating mantle, mechanical stirrer, thermometer, distillation head, and nitrogen inlet. The mixture is heated to 90° C-95° C. for 5 h in the presence of enough sodium hydroxide to maintain pH>9.0. The resulting betaine product is diluted with water and characterized. Betaines: 20-25 wt. %; sodium chloride: 4.5 wt. %; water: 45-50 wt. %.

### Preparation of a Viscoelastic Composition (“VES”)

TOFA amidoamine betaine samples prepared as described above are generally used “as is” for the viscoelastic composition. In some aspects, it may be desirable to adjust the proportion of ethanol, propylene glycol, or both to produce mixture that contains 40-50 wt. % water and a weight ratio of propylene glycol to ethanol within the range of 1.5:1 to 3.0:1, where the amounts are based on the total amount of viscoelastic composition.

### Evaluation of Viscoelastic Compositions

### 1. Spent Acid Preparation

Reaction of hydrochloric acid with carbonate-rich formations generates carbon dioxide and calcium chloride. In the presence of a viscoelastic surfactant, the reactions cause spherical micelles to develop into worm-like micelles, which entangle to form three-dimensional network structures. As a result, the apparent viscosity of the solution increases. To mimic this behavior, the viscoelastic compositions are combined at typical dosing levels (e.g., 4.0 to 6.0 vol. % of viscoelastic composition) with calcium chloride (20 wt. %, equivalent to about 15 wt. % HCl), a commercial corrosion inhibitor (1.0 to 3.0 vol. %), and deionized water (q.s. to 100 vol. %). The pH is adjusted with a few drops of HCl to 4.0 to 5.0. Mixtures are centrifuged at 2500 rpm for 10 min. to remove trapped air prior to testing.

### 2. Viscosity Measurements

A high-pressure, high-temperature rheometer (Grace M5600 HPHT rheometer) is used to measure the viscosity of the spent acid mixtures at temperatures ranging from 150° F. to 350° F. at 400 psi and at shear rates of 10 s⁻¹ to 100 s⁻¹. For each 2-hour test run, about 50 mL of freshly prepared sample is used. In a successful test, the composition remains viscoelastic during the test with a viscosity that is relatively stable or increases with time. At higher shear rates, viscosities are reduced, but at the 100 s⁻¹ shear rate, a successful 2-h viscosity is at least about 100 cP. Representative results appear in Table 1. Additional runs performed at 6.0 vol. % VES and 2.0 vol. % of a commercial corrosion inhibitor at 250° F. and 100 s⁻¹ give 2-h viscosities within the range of 80 to 250 cP.

For additional experimental details, see A.F. Ibrahim et al., SPE-191606-MS, “Evaluation of New Viscoelastic Surfactant Systems in High-Temperature Carbonates Acidizing,” presented at the SPE Annual Technical Conference and Exhibition, 24-26 Sep. 2018, Dallas, Tex.

TABLE 1
Results with TOFA amidoamine betaine VES systems at 400 psi

| | VES, | Temp, | corrosion | 2-h viscosity | 2-h viscosity |
|---|---|---|---|---|---|
| Ex. | vol. % | ° F. | inhibitor, vol. % | at 10 s⁻¹, cP | at 100 s⁻¹, cP |
| 1 | 6.0 | 150 | 0 | 450 | 70 |
| 2 | 6.0 | 150 | 1.0 | 2000 | 220 |
| 3 | 6.0 | 200 | 1.0 | | 180 |
| 4 | 6.0 | 250 | 2.0 | | 200 |
| 5 | 4.0 | 250 | 2.0 | | 250 |
| 6 | 6.0 | 300 | 3.0 | | 300 |
| 7 | 6.0 | 350 | 3.0 | | 240 |

VES = mixture of TOFA amidoamine betaine (20-35 wt. % actives) with ethanol (4-10 wt. %) and propylene glycol (12-15 wt. %).

Examples 1 and 2 reveal excellent compatibility and a synergistic effect between the TOFA amidoamine betaine VES and the commercial corrosion inhibitor. At either tested shear rate (10 s⁻¹ or 100 s⁻¹), the two-hour viscosity value increases significantly with a commercial corrosion inhibitor present. Usually, adding a corrosion inhibitor reduces the viscosity under shear conditions, but here the opposite is true.

The synergistic effect is also evident from a comparison of experiments performed at different temperatures. Normally, it is more difficult to maintain a high two-hour viscosity as temperature is increased. The effect of increasing temperature is apparent when comparing Examples 2 and 3 (2-h viscosity decreases from 220 cP at 150° F. to 180 cP at 200° F.) or Examples 6 and 7 (2-h viscosity decreases from 300 cP at 300° F. to 240 cP at 350° F.). Here, although there is a viscosity decrease with increasing temperature, the overall viscosity remains desirably high.

Surprisingly, the 2-h viscosities generally increase with increasing temperature and increasing concentration of corrosion inhibitor, with the highest 2-h viscosity of 300 cP occurring at 300° F. and 3.0 vol. % corrosion inhibitor. This demonstrates synergy between the corrosion inhibitor and the TOFA amidoamine betaine VES system.

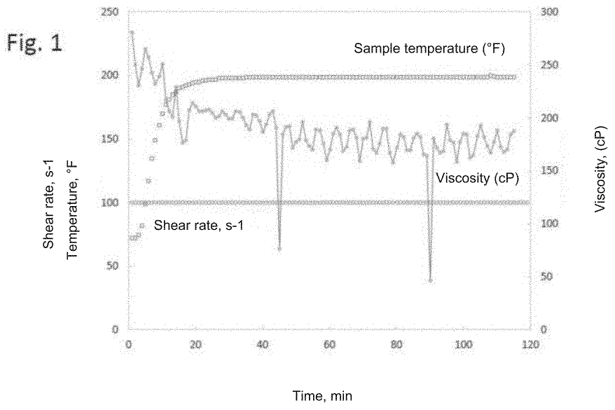

Example 4 is further illustrated by FIG. 1. For this experiment, the viscoelastic composition includes a TOFA amidoamine betaine and 6.0 vol. % of the VES is used along with 2 vol. % corrosion inhibitor and 20 wt. % CaCl₂ at 400 psi. As shown in the figure, the shear rate is held constant at 100 s⁻¹. Temperature is ramped quickly to 250° F. where it remains for the rest of the two-hour test. Viscosity remains high and relatively constant at about 200 cP. (The apparent sharp dips, e.g., at 20 and 70 minutes, are artifacts that can be ignored.)

Example 5 shows that the TOFA amidoamine betaine system can tolerate dosage levels well below the usual 6.0 vol. %. At only 4.0 vol. % VES and 2.0 vol. % corrosion inhibitor at 250° F. (i.e., relatively stressed conditions), the 2-h viscosity at 100 5⁻¹ remains high at 250 cP, thus providing a cost-savings opportunity for the practitioner.

### Iron(III) Tolerance

The presence of certain ions in subterranean formations can cause undesirable phase separations to occur during matrix acidizing. Iron(III) content, for instance, can adversely impact performance of viscoelastic surfactant systems.

In a series of experiments, hydrochloric acid (15 wt. % aq. HCl) is combined with water, 6.0 vol. % of TOFA amidoamine betaine-based VES, and various concentrations of ferric chloride. At Fe(III) concentrations of 5,000 ppm and 10,000 ppm, no phase separation is observed, whereas phase separation is apparent at 15,000 ppm.

Literature for AkzoNobel's ARMOVIS® EHS product suggests that phase separation occurs with most conventional viscoelastic systems (dosed at 4 wt. % VES) at 3,000 ppm Fe(III) or less, although its new system can apparently tolerate at least 9,000 ppm of Fe(III).

Post-Flush with Mutual Solvent

After an acidizing process is complete, it is necessary to break down gels to prevent formation damage, generate clean wormholes, facilitate oil recovery, and promote removal of the surfactant system from the subterranean formation. For this, a “mutual solvent” is added.

Addition of 1,2-butylene glycol (3.0 vol. %) to a 6.0 vol. % VES system in the above experiments quickly reduces the viscosity to 0 cP under the test conditions of 250° F., 100 s⁻¹, and to about 20 cP at room temperature.

### Effect of Propylene Glycol to Ethanol Ratio

In another series of experiments, the ratio of propylene glycol to ethanol is varied. For each experiment, a TOFA amidoamine betaine-based VES is used at 6 vol. % with propylene glycol and ethanol included in the proportion shown in Table 2. The viscosity is then evaluated at 400 psi, 200° F., and a shear rate of 100 s⁻¹. As shown in the table, the ratio of PG/EtOH can impact the success or failure of the formulation in achieving a satisfactory and stable viscosity with the TOFA amidoamine betaine.

TABLE 2
Effect of Propylene Glycol to Ethanol Proportion

| | | | wt. ratio | 2-hour viscosity, |
|---|---|---|---|---|
| Ex. | PG, wt. % | EtOH, wt. % | PG/EtOH | cP at 100 s⁻¹ |
| 8 | 13.9 | 6.8 | 2.0 | 175 |
| 9 | 14.5 | 5.9 | 2.5 | 250 |
| C10 | 15.3 | 2.9 | 5.3 | 0 |
| C11 | 13.7 | 3.3 | 4.2 | 0 |

### Coreflood Experiments

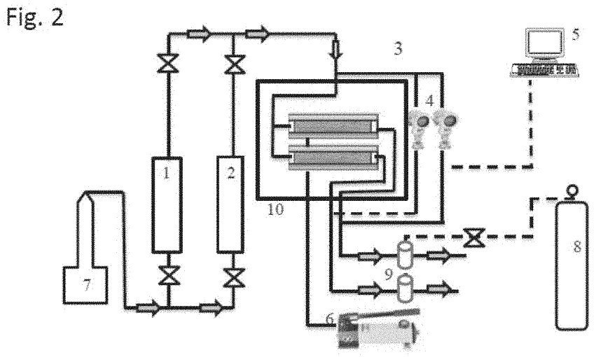

To investigate the capability of the VES system to divert acid flow, single and dual coreflood experiments are performed using high- and low-permeability Indiana limestone cores. FIG. 2 shows a schematic for the coreflood setup used. Two piston accumulators with a capacity of 2 L are used to store the live acid system and deionized water. A syringe pump is used to inject the solutions from the piston accumulators. The core is inserted on a Hassler-type core holder. The back-pressure regulator is installed at the outlet and is controlled using nitrogen. The back pressure is set at 1100 psi to ensure that the reaction products remain soluble in the spent acid. The overburden pressure is set at 1800 psi using a hand pump. The pressure drop across the core is monitored using a pressure transducer, which is connected to a computer to the record data using LabVIEW™ software. For the dual coreflood experiments, the setup is adjusted to have two core holders connected from the inlet in series, two back pressure regulators, and two pressure transducers.

### Core Preparation

Indiana limestone cores with a permeability range from 7 to 150 md are used. The cores are dried at 150° F. overnight and the dry weight is measured. The cores are saturated with deionized water under vacuum for 4 h and are then left submerged in the water for 24 h. The cores are then inserted into the core holder to measure the initial permeability at room temperature.

### Live Acid Preparation

Live acid is used for the coreflood experiments. Corrosion inhibitor is added at 1.0 vol. % to 3.0 vol. % at 250° F. to 300° F. At 250° F., 2.0 vol. % corrosion inhibitor is used with 3 vol. % formic acid as an intensifier. A magnetic stirrer is used to mix the solution for 5 min. Hydrochloric acid is then added to reach 15 wt. % HCl concentration. The acid system is mixed for 15 min., then transferred to the acid accumulator. The acid mixture is prepared within 0.5 h of its injection to minimize phase separation of the corrosion inhibitor.

### Coreflood Procedure

For single-core experiments, a core with an average permeability of 7 md at 1 mL/min and temperatures from 150° F. to 300° F. are used. The core is inserted into the holder and the oven is heated to the desired temperature. Deionized water is injected at 1 mL/min for 3 h to ensure a stable system. Thereafter, live acid is injected and effluent samples are collected every 0.33 pore volume. The pressure drop across the core is monitored until breakthrough occurs, which corresponds to a sudden pressure drop across the core. The system is then flushed with deionized water and shut down. The cores are scanned by computed tomography (CT), and the effluent samples are analyzed using inductive coupled plasma (ICP) to determine Ca⁺² concentrations. For dual-core experiments, cores having a permeability contrast from 2 to 10 are used.

Results from Coreflood Experiments

The performance of the inventive TOFA amidoamine betaine system is compared to that of a commercial sultaine-based viscoelastic surfactant.

1. Single-Core Experiments

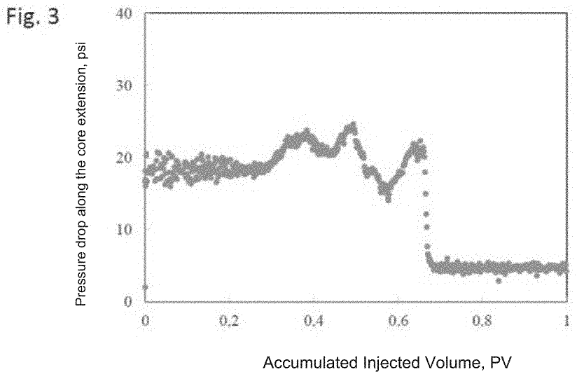

For the sultaine-based system (see FIG. 3), the pressure drop is stable at 17.5 psi during deionized water injection. When the acid reaches the core inlet, the pressure drop across the core increases due to the change of the viscosity from deionized water to VES-acid and the reaction with core matrix. This is followed by three intervals of pressure drop increase and decrease with a fluctuation magnitude of 5 to 10 psi. This fluctuation is a typical response for in-situ gelled acids and results from dissolution of the calcite minerals, followed by gel formation and acid diversion. A pressure drop to zero indicates breakthrough. Volume of injected acid at breakthrough: 0.5 PV.

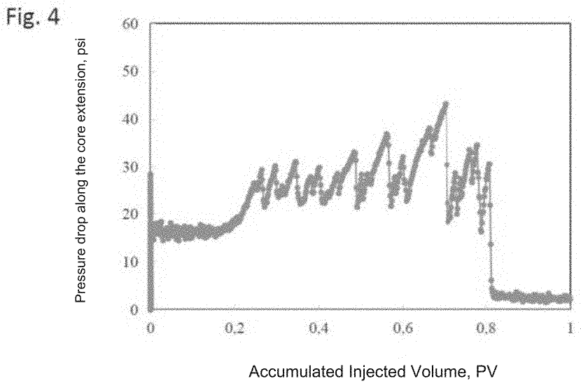

For the TOFA amidoamine betaine-based system (FIG. 4), the pressure drop across the core stabilizes at 16 psi during DI injection. During acid injection, successive pressure drop fluctuations up to 17 times are observed, indicating more gel formations and successful diversion of acid. Volume of injected acid at breakthrough: 0.6 PV.

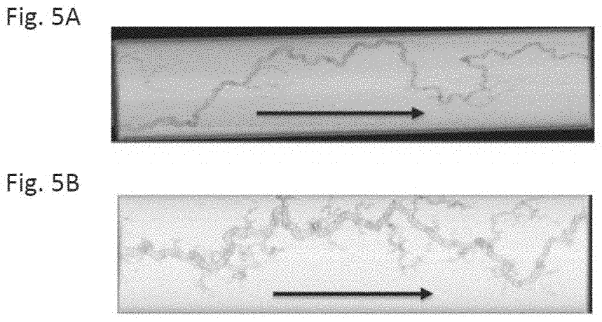

CT scans of the cores show wormhole diversion in both cases. The wormhole tortuosity (wormhole length/core length) is 1.8 for the TOFA amidoamine-based VES (FIG. 5B) and 1.4 for the sultaine-based system (FIG. 5A). This indicates greater capability to divert acid in the inventive VES system.

Additional coreflood experiments are conducted at 250° F. and 300° F. using live acid and the TOFA amidoamine betaine system. At 250° F., 2.0 vol. % of the corrosion inhibitor and 3.0 vol. % formic acid (intensifier) are used. The pressure stabilizes at 15.5 psi during water injection and then increases as the acid reaches the core inlet. Fluctuations in pressure drop are observed, indicating acid diversion. Breakthrough occurs after injection of 0.52 PV. A CT scan of the core after acid treatment shows branching and a well-diverted wormhole.

Further experiments are performed at 300° F. The concentration of corrosion inhibitor is increased to 3.0 vol. %, and 3.0 vol. % of formic acid is included. The pressure stabilizes at 15.9 psi during water injection, then increases as the acid reaches the core inlet. Fluctuations in pressure drop are observed, indicating acid diversion. Breakthrough occurs after injection of 0.4 PV. A CT scan of the core confirms the ability of the inventive VES to generate a good wormhole along the core and divert acid at high temperature.

The single coreflood experiments reveal substantial acid diversion capability of the inventive VES system, with a wormhole length that can be double that of the core length.

2. Dual-Core Experiments

Dual coreflood experiments are conducted on Indiana limestone cores at 250° F. and an injection flowrate of 3 mL/min. The live acid system consists of 15 wt. % HCl, 6.0 vol. % of TOFA amidoamine betaine-based VES, 2.0 vol. % of corrosion inhibitor, and 3.0 vol. % of formic acid. Two experiments are conducted to evaluate the effect of permeability contrast on the ability of the inventive VES to divert acid.

For a first experiment, cores with permeabilities of 80 and 14.8 md are used; the corresponding initial permeability contrast is 5.4. The pressure drop is stable at 8.5 psi during the water injection, then increases when the acid reaches the high permeability core inlet. Breakthrough occurs at 0.8 PV, which is calculated based on the pore volume for both cores.

The CT scan of the cores after acid treatment shows clear acid breakthrough on the inlets and outlets of both cores. The low-permeability core shows some branching from the main wormhole, while the high-permeability core shows a straight, single wormhole.

In a second experiment, cores with permeabilities of 224 and 9 md are used; the corresponding initial permeability contrast is much higher at 25. The pressure drop stabilizes at 6.4 psi during water injection and increases as the acid reacts with the rock. Breakthrough occurs at 0.71 PV. A CT scan of the cores after acid treatment shows that although breakthrough occurred on the high-permeability core, the wormhole propagated to about 47% of the length of the low-permeability core. The results demonstrate substantial diversion capability of the inventive VES system.

The dual coreflood experiments further underscore the high diversion capability for the inventive TOFA amidoamine betaine VES system, where the stimulation percent of the low-permeability cores are 100% and 47% at permeability contrasts of 5.4 and 25, respectively.

The preceding examples are mere illustrations; those skilled in the art will recognize variations that are within the spirit of the invention and the scope of the claims.

We claim:

1. A viscoelastic composition, suitable for use as a diversion agent in a process for acidizing a carbonate-based subterranean oilfield formation, comprising:
(a) 20 to 35 wt. % of a tall oil fatty acid (TOFA)-based amidoamine betaine;
(b) 5 to 10 wt. % of a C₁-C₄ alcohol;
(c) 10 to 20 wt. % of propylene glycol; and
(d) 30 to 60 wt. % of water;
wherein said wt. % amounts are based on the amount of viscoelastic composition.

2. The composition of claim 1 wherein the betaine is based on a TOFA comprising 5 to 10 wt. % of palmitic acid, 40 to 55 wt. % of oleic acid, and 35 to 45 wt. % of linoleic acid, said wt. % amounts based on the amount of TOFA.

3. The composition of claim 1 wherein the C₁-C₄ alcohol is ethanol.

4. The composition of claim 3 wherein the weight ratio of propylene glycol to ethanol is within the range of 3:1 to 1.5:1.

5. The composition of claim 1 wherein the betaine has the structure: 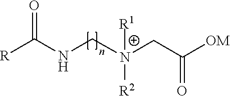
wherein n has a value from 1 to 4, R is a saturated or unsaturated fatty chain from tall oil, R¹ and R² are independently methyl or ethyl, M is an alkali metal cation or an ammonium cation, and
wherein the betaine is based on a TOFA comprising 5 to 10 wt. % of palmitic acid, 35 to 55 wt. % of oleic acid, and 30 to 45 wt. % of linoleic acid, said wt. % amounts based on the amount of TOFA.

6. The composition of claim 5 wherein the betaine is based on a TOFA comprising 1 to 3 wt. % of stearic acid.

7. The composition of claim 5 wherein the betaine is based on a TOFA comprising 6 to 8 wt. % of palmitic acid, 1.5 to 3 wt. % of stearic acid, 40 to 52 wt. % of oleic acid, and 35 to 42 wt. % of linoleic acid.

8. A process which comprises acidizing a carbonate-rich subterranean oilfield formation with an acidizing medium comprising a mineral acid and an effective amount of the viscoelastic composition of claim 1.

9. The process of claim 8 wherein the mineral acid is hydrochloric acid.

10. The process of claim 8 wherein the viscoelastic composition is dosed to the formation at a level within the range of 4 to 10 vol. % based on the combined amounts of acidizing medium and viscoelastic composition.

11. The process of claim 8 wherein the acidizing is performed at a temperature within the range of 200° F. to 400° F. and at a pressure within the range of 200 psi to 500 psi.

12. The process of claim 8 wherein the formation contains 1,000 to 10,000 ppm of iron(III) content.

13. The process of claim 8 wherein the acidizing is performed in the presence of a corrosion inhibitor.
